(19) United States
(12) Patent Application Publication
(10) Pub. No.: US 2018/0341723 A1
(43) Pub. Date: Nov. 29, 2018

(54) TRIGGERING UNTRIGGERED ASSERTIONS IN DESIGN VERIFICATION

(71) Applicant: SanDisk Technologies LLC, Plano, TX (US)

(72) Inventors: ANANTHARAJ THALAIMALAI VANARAJ, Bangalore (IN); MASSOUD HADJIMOHAMMADI, Danville, CA (US); RAJESH KUMAR NARAYANA PERUMAL, Bangalore (IN); SRINIVASA YALAVATTI, Bangalore (IN)

(73) Assignee: SanDisk Technologies LLC, Plano, TX (US)

(21) Appl. No.: 15/605,719

(22) Filed: May 25, 2017

(51) Int. Cl. G06F 17/50

(52) U.S. Cl. CPC G06F 17/504

(57) ABSTRACT

Apparatuses, systems, methods, and computer program products are disclosed for triggering untriggered assertions in design verification. A method includes determining one or more assertions of a plurality of assertions that are not triggered while validating one or more behaviors of an integrated circuit (“IC”) design. A plurality of assertions may be intended to test a validity of one or more behaviors of an IC design. A method includes determining one or more dependencies for one or more untriggered assertions. One or more dependencies for an untriggered assertion may affect how an assertion is triggered. A method includes generating one or more testing scenarios for an IC design, based on one or more dependencies, for triggering one or more untriggered assertions.

### TECHNICAL FIELD

The present disclosure, in various embodiments, relates to testing integrated circuit devices and more particularly relates to triggering assertions that were not triggered during a verification test of an integrated circuit design.

### BACKGROUND

Integrated circuit (“IC”) designs may include various gates, operations, functions, behaviors, or the like that may be validated before, or while, an IC is placed in production. To generate and verify such complex IC designs, a constraint random verification method may be used; however, using a random approach may not achieve full verification coverage of an IC design.

### SUMMARY

Methods are presented to trigger untriggered assertions in design verification. In one embodiment, a method includes determining one or more assertions of a plurality of assertions that are not triggered while validating one or more behaviors of an integrated circuit (“IC”) design. A plurality of assertions may be intended to test a validity of one or more behaviors of an IC design. A method, in a further embodiment, includes determining one or more dependencies for one or more untriggered assertions. One or more dependencies for an untriggered assertion may affect how an assertion is triggered. A method, in some embodiments, includes generating one or more testing scenarios for an IC design, based on one or more dependencies, for triggering one or more untriggered assertions.

Apparatuses are presented to trigger untriggered assertions in design verification. In one embodiment, an apparatus includes means for determining one or more tests that were not triggered for execution during validation testing of an integrated circuit (“IC”). An apparatus, in a further embodiment, includes means for determining one or more conditions that trigger execution of one or more untriggered tests during validation testing of an IC. An apparatus, in some embodiments, includes means for simulating execution of one or more untriggered tests by modifying one or more conditions to trigger execution of the one or more tests.

Computer program products are presented to trigger untriggered assertions in design verification. In one embodiment, a computer program product includes a computer readable storage medium that stores computer usable code that is executable to perform operations. In one embodiment, an operation includes executing a verification test for an integrated circuit (“IC”). A verification test may include one or more assertions configured to test one or more operations of an IC. In some embodiments, an operation includes determining one or more assertions of a verification test that were not triggered during execution of a verification test. In some embodiments, an operation includes re-executing, dynamically, a verification test with one or more adjusted parameters. In certain embodiments, one or more adjusted parameters are associated with one or more dependencies that affect triggering of one or more untriggered assertions.

### BRIEF DESCRIPTION OF THE DRAWINGS

A more particular description is included below with reference to specific embodiments illustrated in the appended drawings. Understanding that these drawings depict only certain embodiments of the disclosure and are not therefore to be considered to be limiting of its scope, the disclosure is described and explained with additional specificity and detail through the use of the accompanying drawings, in which:

FIG. 1 is a schematic block diagram illustrating one embodiment of a system for triggering untriggered assertions in design verification;

FIG. 2 is a schematic block diagram illustrating one embodiment of an integrated circuit design;

FIG. 3 is a schematic block diagram illustrating one embodiment of a design validation module;

FIG. 4 is a schematic block diagram illustrating another embodiment of a design validation module;

FIG. 5 is a schematic flow chart diagram illustrating one embodiment of a method for triggering untriggered assertions in design verification; and

FIG. 6 is a schematic flow chart diagram illustrating an embodiment of another method for triggering untriggered assertions in design verification.

### DETAILED DESCRIPTION

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “circuit,” “module,” “apparatus,” or “system.” Furthermore, aspects of the present disclosure may take the form of a computer program product embodied in one or more non-transitory computer readable storage media storing computer readable and/or executable program code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented at least partially in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may include a single instruction, or many instructions, and may even be distributed over several different code segments, among different programs, across several memory devices, or the like. Where a module or portions of a module are implemented in software, the software portions may be stored on one or more computer readable and/or executable storage media. Any combination of one or more computer readable storage media may be utilized. A computer readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the modules described herein, in certain embodiments, may alternatively be embodied by or implemented as a component.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

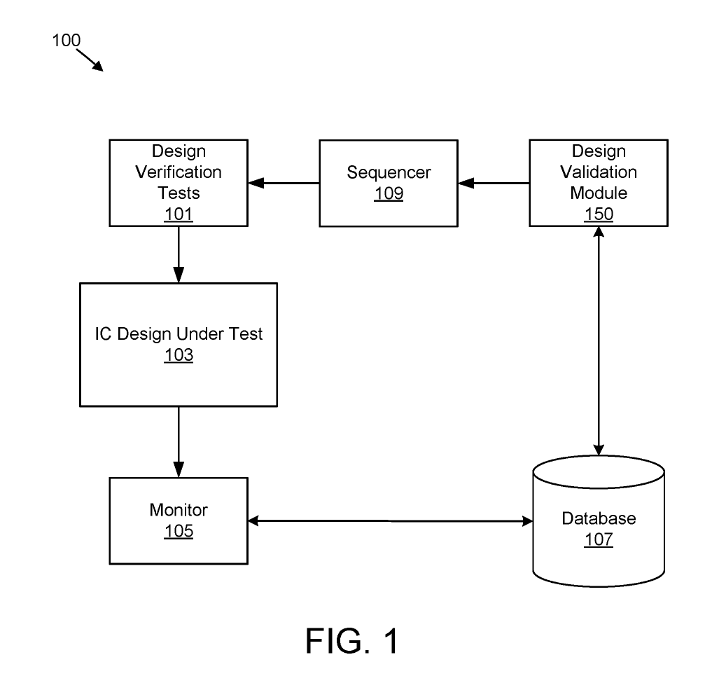

FIG. 1 is a schematic block diagram illustrating one embodiment of a system 100 for triggering untriggered assertions in design verification. In one embodiment, the system 100 includes one or more design verification tests 101, one or more integrated circuit (“IC”) designs under test (“DUT”) 103, one or more monitors 105, one or more databases 107, one or more design validation modules 150, and one or more sequencers 109. In certain embodiments, even though a specific number of design verification tests 101, ICDUTs 103, monitors 105, databases 107, design validation modules 150, and sequencers 109 are depicted in FIG. 1, one of skill in the art will recognize, in light of this disclosure, that any number of design verification tests 101, ICDUTs 103, monitors 105, databases 107, design validation modules 150, and sequencers 109 may be included in the system 100.

In one embodiment, the design verification tests 101 are configured to test one or more behaviors, functions, operations, and/or the like of the ICDUT 103. The design verification tests 101 may include a sequence of events that are configured to trigger one or more assertions, where each assertion is intended to test an operation, function, command, instruction, and/or the like of the ICDUT 103. The design verification tests 101 may include code files, text files, configuration files, and/or the like that describe the functions, operations, signals, events, and/or the like, and/or an execution sequence, for testing the various operations of the ICDUT 103.

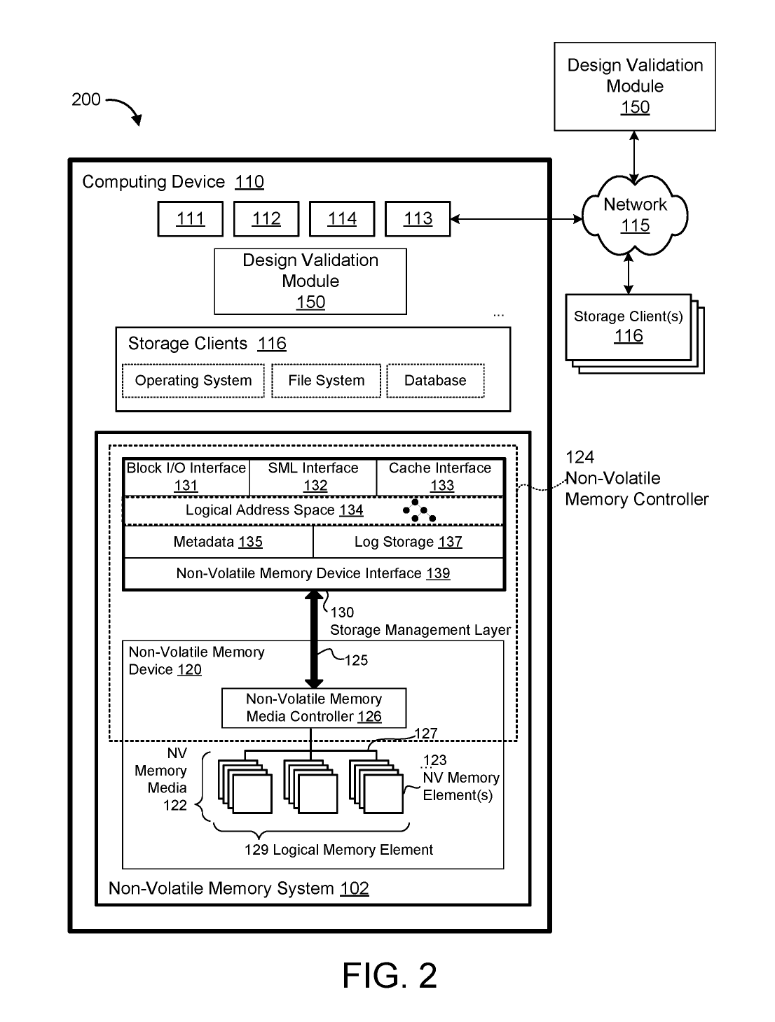

The ICDUT 103, as described in more detail below with reference to FIG. 2, comprises a design of an integrated circuit, such as a memory device, a processor, a storage device, a network card, and/or the like. In certain embodiments, the ICDUT 103 may comprise designs for a plurality of components of a system such as a computer, a server, a mobile device, and/or the like. One of skill in the art will recognize, in light of this disclosure, the various integrated circuits that may be tested.

In one embodiment, the monitor 105 may be a software and/or hardware module that monitors and tracks the results of a verification test that is executed on the ICDUT 103. The monitor 105, for example, may track which assertions are triggered, what caused an assertion to be triggered, what the values of various variables or dependencies are when an assertion is triggered, and/or the like. The monitor 105 may store the verification test result information in a database 107, or other data store.

In one embodiment, the database 107 may comprise a data store for storing the information from the results of a verification test that the monitor 105 monitors. In particular, in one embodiment, the database 107 stores identifiers for assertions that are triggered and assertions that are not triggered during a verification test, and the dependencies that may cause the assertions to be triggered. The database 107 may comprise a relational database, a list, a file, and/or any other type of data store for storing and accessing data.

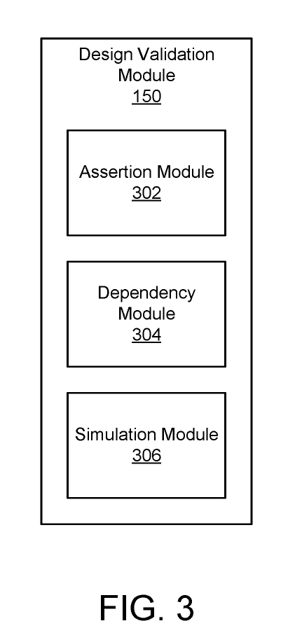

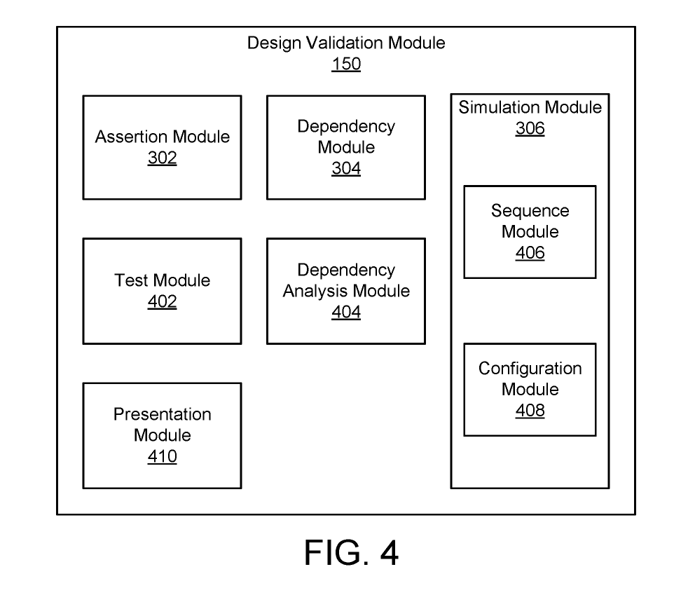

In one embodiment, the design validation module 150 is configured to determine one or more assertions of a design verification test 101 or simulation for an ICDUT 103 that were not triggered during the test 101, determine which conditions cause the untriggered assertions to be triggered (e.g., by referencing the database 107), and generate a simulation to trigger the untriggered assertions based on various modifications to the triggering conditions. In this manner, the design validation module 150 may ensure that assertions that are skipped because certain triggering events didn't occur can be triggered during a design test simulation to achieve full test coverage of the integrated circuit. The design validation module 150, including its various sub-modules, may be located on one or more information handling devices 101 in the system 100, one or more servers 103, one or more network devices, one or more security systems, and/or the like. The design validation module 150 is described in more detail below with reference to FIGS. 3 and 4.

The design validation module 150, in some embodiments, provides an improvement over conventional IC design verification systems, especially manual systems, by providing better verification quality, e.g., uncovering hidden bugs in a plurality of scenarios; improving productivity; and reducing the verification time. Conventional verification systems may require a user to scan a log file for untriggered assertions, check for problems with the assertion, rewrite the assertion if there is a problem, and/or query a designer as to why a particular assertion was not triggered. Furthermore, a design engineer may have to understand the untriggered assertions, manually trace the dependencies associated with the assertions, and understand which values of the dependencies may cause the assertion to trigger. A user may then have to manually generate a scenario, based on the identified dependencies and dependency values, to trigger the untriggered assertions, which may take hundreds of man-hours to accomplish, unlike the design validation module 150 disclosed herein.

In various embodiments, the design validation module 150 may be embodied as a hardware appliance that can be installed or deployed on an information handling device 101, on a server 103, or elsewhere on the data network 115. In certain embodiments, the design validation module 150 may include a hardware device such as a secure hardware dongle or other hardware appliance device (e.g., a set-top box, a network appliance, or the like) that attaches to a device such as a laptop computer, a server 103, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the design validation module 150 may include a power interface, a wired and/or wireless network interface, a graphical interface that attaches to a display, and/or a semiconductor integrated circuit device as described below, configured to perform the functions described herein with regard to the design validation module 150.

The design validation module 150, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the design validation module 150 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the design validation module 150.

The semiconductor integrated circuit device or other hardware appliance of the design validation module 150, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the design validation module 150 includes and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

In one embodiment, the sequencer 109 determines a sequence of events, functions, commands, operations instructions, signals, and/or the like, based on design validation module 150, that may cause untriggered assertions to be triggered. The sequencer 109 may generate or provide input for a different design verification test 101 that may be executed on the ICDUT 103 to trigger execution of the assertions that were not triggered during a previous design verification test 101.

FIG. 2 is a block diagram of one embodiment of a system 100 comprising a design validation module 150. In certain embodiments, the design validation module 150 runs design verification tests 101 against a tangible embodiment of the system 150 and/or against a simulation of the system 150 to test the design, operations, and/or behavior of the various components of the system 150, as described below. In certain embodiments, at least a portion of the design validation module 150 is located on the computing device 110, and/or is communicatively coupled to the computing device 110 via the network 115.

The design validation module 150 may be part of and/or in communication with one or more of a non-volatile memory controller 124, a non-volatile memory media controller 126, a device driver or storage management layer (SML) 130, or the like. The design validation module 150 may operate on a non-volatile memory system 102 of a computing device 110, which may comprise a processor 111, volatile memory 112, and a communication interface 113. The processor 111 may comprise one or more central processing units, one or more general-purpose processors, one or more application-specific processors, one or more virtual processors (e.g., the computing device 110 may be a virtual machine operating within a host), one or more processor cores, or the like. The communication interface 113 may comprise one or more network interfaces configured to communicatively couple the computing device 110 and/or non-volatile memory controller 124 to a communication network 115, such as an Internet Protocol network, a Storage Area Network, or the like.

The computing device 110 may further comprise a non-transitory, computer readable storage media 114. The computer readable storage media 114 may comprise executable instructions configured to cause the computing device 110 (e.g., processor 111) to perform steps of one or more of the methods disclosed herein. Alternatively, or in addition, the design validation module 150 may be embodied as one or more computer readable instructions stored on the non-transitory storage media 114.

In one embodiment, the design validation module 150 may comprise executable software code, such as a device driver, SML 130, or the like, stored on the computer readable storage media 114 for execution on the processor 111. In another embodiment the design validation module 150 may comprise logic hardware of one or more non-volatile memory devices 120, such as a non-volatile memory media controller 126, a non-volatile memory controller 124, a device controller, a field-programmable gate array (FPGA) or other programmable logic, firmware for an FPGA or other programmable logic, microcode for execution on a microcontroller, an application-specific integrated circuit (ASIC), or the like. In a further embodiment, the design validation module 150 may include a combination of both executable software code and logic hardware.

In one embodiment, the design validation module 150 is configured to receive storage requests from the SML 130 via a bus 125 or the like. The design validation module 150 may be further configured to transfer data to/from the SML 130 and/or storage clients 116 via the bus 125. Accordingly, the design validation module 150, in some embodiments, may comprise and/or be in communication with one or more direct memory access (DMA) modules, remote DMA modules, bus controllers, bridges, buffers, and so on to facilitate the transfer of storage requests and associated data. In another embodiment, the design validation module 150 may receive storage requests as an API call from a storage client 116, as an IO-CTL command, or the like. The design validation module 150 is described in greater detail below with regard to FIGS. 3 and 4.

According to various embodiments, a non-volatile memory controller 124 comprising the design validation module 150 may manage one or more non-volatile memory devices 120. The non-volatile memory device(s) 120 may comprise recording, memory, and/or storage devices, such as solid-state storage device(s), that are arranged and/or partitioned into a plurality of addressable media storage locations. As used herein, a media storage location refers to any physical unit of memory (e.g., any quantity of physical storage media on a non-volatile memory device 120). Memory units may include, but are not limited to: pages, memory divisions, erase blocks, sectors, blocks, collections or sets of physical storage locations (e.g., logical pages, logical erase blocks, described below), or the like.

The non-volatile memory controller 124 may comprise an SML 130, which may present a logical address space 134 to one or more storage clients 116. One example of an SML is the Virtual Storage Layer® of SanDisk Corporation of Milpitas, California. Alternatively, each non-volatile memory device 120 may comprise a non-volatile memory media controller 126, which may present a logical address space 134 to the storage clients 116. As used herein, a logical address space 134 refers to a logical representation of memory resources. The logical address space 134 may comprise a plurality (e.g., range) of logical addresses. As used herein, a logical address refers to any identifier for referencing a memory resource (e.g., data), including, but not limited to: a logical block address (LBA), cylinder/head/sector (CHS) address, a file name, an object identifier, an inode, a Universally Unique Identifier (UUID), a Globally Unique Identifier (GUID), a hash code, a signature, an index entry, a range, an extent, or the like.

The SML 130 may maintain metadata 135, such as a forward index, to map logical addresses of the logical address space 134 to media storage locations on the non-volatile memory device(s) 120. The SML 130 may provide for arbitrary, any-to-any mappings from logical addresses to physical storage resources. As used herein, an “any-to any” mapping may map any logical address to any physical storage resource. Accordingly, there may be no pre-defined and/or pre-set mappings between logical addresses and particular, media storage locations and/or media addresses. As used herein, a media address refers to an address of a memory resource that uniquely identifies one memory resource from another to a controller that manages a plurality of memory resources. By way of example, a media address includes, but is not limited to: the address of a media storage location, a physical memory unit, a collection of physical memory units (e.g., a logical memory unit), a portion of a memory unit (e.g., a logical memory unit address and offset, range, and/or extent), or the like. Accordingly, the SML 130 may map logical addresses to physical data resources of any size and/or granularity, which may or may not correspond to the underlying data partitioning scheme of the non-volatile memory device(s) 120. For example, in some embodiments, the non-volatile memory controller 124 is configured to store data within logical memory units that are formed by logically combining a plurality of physical memory units, which may allow the non-volatile memory controller 124 to support many different virtual memory unit sizes and/or granularities.

As used herein, a logical memory element refers to a set of two or more non-volatile memory elements that are or are capable of being managed in parallel (e.g., via an I/O and/or control bus). A logical memory element may comprise a plurality of logical memory units, such as logical pages, logical memory divisions (e.g., logical erase blocks), and so on. As used herein, a logical memory unit refers to a logical construct combining two or more physical memory units, each physical memory unit on a respective non-volatile memory element in the respective logical memory element (e.g., each non-volatile memory element being accessible in parallel). As used herein, a logical memory division refers to a set of two or more physical memory divisions, each physical memory division on a respective non-volatile memory element in the respective logical memory element.

The logical address space 134 presented by the SML 130 may have a logical capacity, which may correspond to the number of available logical addresses in the logical address space 134 and the size and/or granularity of the data referenced by the logical addresses. For example, the logical capacity of a logical address space 134 comprising 2̂32 unique logical addresses, each referencing 2048 bytes (2 KiB) of data may be 2̂43 bytes. As used herein, a kibibyte (KiB) refers to 1024 bytes. In some embodiments, the logical address space 134 may be thinly provisioned. As used herein, a “thinly provisioned” logical address space 134 refers to a logical address space 134 having a logical capacity that exceeds the physical capacity of the underlying non-volatile memory device(s) 120. For example, the SML 130 may present a 64-bit logical address space 134 to the storage clients 116 (e.g., a logical address space 134 referenced by 64-bit logical addresses), which may exceed the physical capacity of the underlying non-volatile memory devices 120. The large logical address space 134 may allow storage clients 116 to allocate and/or reference contiguous ranges of logical addresses, while reducing the chance of naming conflicts. The SML 130 may leverage the any-to-any mappings between logical addresses and physical storage resources to manage the logical address space 134 independently of the underlying physical storage devices 120. For example, the SML 130 may add and/or remove physical storage resources seamlessly, as needed, and without changing the logical addresses used by the storage clients 116.

The non-volatile memory controller 124 may be configured to store data in a contextual format. As used herein, a contextual format refers to a self-describing data format in which persistent contextual metadata is stored with the data on the physical storage media 122. The persistent contextual metadata provides context for the data with which it is stored. In certain embodiments, the persistent contextual metadata uniquely identifies the data with which the persistent contextual metadata is stored. For example, the persistent contextual metadata may uniquely identify a sector or block of data owned by a storage client 116 from other sectors or blocks of data owned by the storage client 116. In a further embodiment, the persistent contextual metadata identifies an operation that is performed on the data. In a further embodiment, the persistent contextual metadata identifies a sequence of operations performed on the data. In a further embodiment, the persistent contextual metadata identifies security controls, a data type, or other attributes of the data. In a certain embodiment, the persistent contextual metadata identifies at least one of a plurality of aspects, including data type, a unique data identifier, an operation, and a sequence of operations performed on the data.

The persistent contextual metadata may include, but is not limited to: a logical address of the data, an identifier of the data (e.g., a file name, object id, label, unique identifier, or the like), reference(s) to other data (e.g., an indicator that the data is associated with other data), a relative position or offset of the data with respect to other data (e.g., file offset, etc.), data size and/or range, and the like. The contextual data format may comprise a packet format comprising a data segment and one or more headers. Alternatively, a contextual data format may associate data with context information in other ways (e.g., in a dedicated index on the non-volatile memory media 122, a memory division index, or the like).

In some embodiments, the contextual data format may allow data context to be determined and/or reconstructed based upon the contents of the non-volatile memory media 122, and independently of other metadata, such as the arbitrary, any-to-any mappings discussed above. Since the media location of data is independent of the logical address of the data, it may be inefficient or impossible to determine the context of data based solely upon the media location or media address of the data. Storing data in a contextual format on the non-volatile memory media 122 may allow data context to be determined without reference to other metadata. For example, the contextual data format may allow the metadata to be reconstructed based only upon the contents of the non-volatile memory media 122 (e.g., reconstruct the any-to-any mappings between logical addresses and media locations).

In some embodiments, the non-volatile memory controller 124 may be configured to store data on one or more asymmetric, write-once media 122, such as solid-state storage media. As used herein, a “write once” storage medium refers to a storage medium that is reinitialized (e.g., erased) each time new data is written or programmed thereon. As used herein, an “asymmetric” storage medium refers to a storage medium 122 having different latencies for different storage operations. Many types of solid-state storage media are asymmetric; for example, a read operation may be much faster than a write/program operation, and a write/program operation may be much faster than an erase operation (e.g., reading the media may be hundreds of times faster than erasing, and tens of times faster than programming the media).

The memory media 122 may be partitioned into memory divisions that can be erased as a group (e.g., erase blocks) in order to, inter alia, account for the asymmetric properties of the media 122 or the like. As such, modifying a single data segment in-place may require erasing the entire erase block comprising the data, and rewriting the modified data to the erase block, along with the original, unchanged data. This may result in inefficient “write amplification,” which may excessively wear the media 122. Therefore, in some embodiments, the non-volatile memory controller 124 may be configured to write data out-of-place. As used herein, writing data “out-of-place” refers to writing data to different media storage location(s) rather than overwriting the data “in-place” (e.g., overwriting the original physical location of the data). Modifying data out-of-place may avoid write amplification, since existing, valid data on the erase block with the data to be modified need not be erased and recopied. Moreover, writing data out-of-place may remove erasure from the latency path of many storage operations (e.g., the erasure latency is no longer part of the critical path of a write operation).

The non-volatile memory controller 124 may comprise one or more processes that operate outside of the regular path for servicing of storage operations (e.g., the “path” for performing a storage operation and/or servicing a storage request). As used herein, the “path for servicing a storage request” or “path for servicing a storage operation” (also referred to as the “critical path”) refers to a series of processing operations needed to service the storage operation or request, such as a read, write, modify, or the like. The path for servicing a storage request may comprise receiving the request from a storage client 116, identifying the logical addresses of the request, performing one or more storage operations on non-volatile memory media 122, and returning a result, such as acknowledgement or data. Processes that occur outside of the path for servicing storage requests may include, but are not limited to: a groomer, de-duplication, and so on. These processes may be implemented autonomously and in the background, so that they do not interfere with or impact the performance of other storage operations and/or requests. Accordingly, these processes may operate independent of servicing storage requests.

In some embodiments, the non-volatile memory controller 124 comprises a groomer, which is configured to reclaim memory divisions (e.g., logical or physical erase blocks) for reuse, using a garbage collection or other storage capacity recovery process. The write out-of-place paradigm implemented by the non-volatile memory controller 124 may result in obsolete or invalid data remaining on the non-volatile memory media 122. For example, overwriting data X with data Y may result in storing Y on a new memory division (e.g., rather than overwriting X in place), and updating the any-to-any mappings of the metadata to identify Y as the valid, up-to-date version of the data. The obsolete version of the data X may be marked as invalid, but may not be immediately removed (e.g., erased), since, as discussed above, erasing X may involve erasing an entire memory division, which is a time-consuming operation and may result in write amplification. Similarly, data that is no longer is use (e.g., deleted or trimmed data) may not be immediately removed. The non-volatile memory media 122 may accumulate a significant amount of invalid data.

A groomer process may operate outside of the critical path for servicing storage operations. The groomer process may reclaim memory divisions so that they can be reused for other storage operations. As used herein, reclaiming a memory division refers to erasing the memory division so that new data may be stored/programmed thereon. Reclaiming a memory division may comprise relocating valid data on the memory division to a new location. The groomer may identify memory divisions for reclamation based upon one or more factors, which may include, but are not limited to: the amount of invalid data in the memory division, the amount of valid data in the memory division, wear on the memory division (e.g., number of erase cycles), time since the memory division was programmed or refreshed, and so on.

The non-volatile memory controller 124 may be further configured to store data in a log format. As described above, a log format refers to a data format that defines an ordered sequence of storage operations performed on a non-volatile memory media 122. In some embodiments, the log format comprises storing data in a pre-determined sequence of media addresses of the non-volatile memory media 122 (e.g., within sequential pages and/or erase blocks of the media 122). The log format may further comprise associating data (e.g., each packet or data segment) with respective sequence indicators. The sequence indicators may be applied to data individually (e.g., applied to each data packet) and/or to data groupings (e.g., packets stored sequentially on a memory division, such as an erase block). In some embodiments, sequence indicators may be applied to memory divisions when the memory divisions are reclaimed (e.g., erased), as described above, and/or when the memory divisions are first used to store data.

In some embodiments the log format may comprise storing data in an “append only” paradigm. The non-volatile memory controller 124, using the log storage module 137 described below or the like, may maintain a current append point at a media address of the non-volatile memory device 120. The append point may be a current memory division and/or offset within a memory division. Data may then be sequentially appended from the append point. The sequential ordering of the data, therefore, may be determined based upon the sequence indicator of the memory division of the data in combination with the sequence of the data within the memory division. Upon reaching the end of a memory division, the non-volatile memory controller 124 may identify the “next” available memory division (e.g., the next memory division that is initialized and ready to store data). The groomer may reclaim memory divisions comprising invalid, stale, and/or deleted data, to ensure that data may continue to be appended to the media log.

The log format described herein may allow valid data to be distinguished from invalid data based upon the contents of the non-volatile memory media 122, and independently of other metadata. As discussed above, invalid data may not be removed from the non-volatile memory media 122 until the memory division comprising the data is reclaimed. Therefore, multiple “versions” of data having the same context may exist on the non-volatile memory media 122 (e.g., multiple versions of data having the same logical addresses). The sequence indicators associated with the data may be used to distinguish invalid versions of data from the current, up-to-date version of the data; the data that is the most recent in the log is the current version, and previous versions may be identified as invalid.

The storage management layer 130 may be configured to provide storage services to one or more storage clients 116. The storage clients 116 may include local storage clients 116 operating on the computing device 110 and/or remote, storage clients 116 accessible via the network 115 and/or network interface 113. The storage clients 116 may include, but are not limited to: operating systems, file systems, database applications, server applications, kernel-level processes, user-level processes, applications, and the like.

The storage management layer 130 comprises and/or is communicatively coupled to one or more non-volatile memory devices 120. The one or more non-volatile memory devices 120 may include different types of non-volatile memory devices including, but not limited to: solid-state storage devices, hard drives, SAN storage resources, or the like. The one or more non-volatile memory devices 120 may comprise one or more respective non-volatile memory media controllers 126 and non-volatile memory media 122. As illustrated in FIG. 1, The SML 130 may provide access to the one or more non-volatile memory devices 120 via a traditional block I/O interface 131. Additionally, the SML 130 may provide access to enhanced functionality (e.g., a large, virtual address space 134) through the SML interface 132. The metadata 135 may be used to manage and/or track storage operations performed through any of the Block I/O interface 131, SML interface 132, cache interface 133, or other, related interfaces.

The cache interface 133 may expose cache-specific features accessible via the storage management layer 130. Also, in some embodiments, the SML interface 132 presented to the storage clients 116 provides access to data transformations implemented by the one or more non-volatile memory devices 120 and/or the one or more non-volatile memory media controllers 126.

The SML 130 may provide storage services through one or more interfaces, which may include, but are not limited to: a block I/O interface, an extended storage management layer interface, a cache interface, and the like. The SML 130 may present a logical address space 134 to the storage clients 116 through one or more interfaces. As discussed above, the logical address space 134 may comprise a plurality of logical addresses, each corresponding to respective media locations the on one or more non-volatile memory devices 120. The SML 130 may maintain metadata 135 comprising any-to-any mappings between logical addresses and media locations, as described above.

The SML 130 may further comprise a log storage module 137 that is configured to store data in a contextual, log format. The contextual, log data format may comprise associating data with persistent contextual metadata, such as the logical address of the data, or the like. The contextual, log format may further comprise associating data with respective sequence identifiers on the non-volatile memory media 122, which define an ordered sequence of storage operations performed on the one or more non-volatile memory devices 120, as described above.

The SML 130 may further comprise a non-volatile memory device interface 139 configured to transfer data, commands, and/or queries to the one or more non-volatile memory devices 120 over a bus 125, which may include, but is not limited to: a peripheral component interconnect express (PCI Express or PCIe) bus, a serial Advanced Technology Attachment (ATA) bus, a parallel ATA bus, a small computer system interface (SCSI), FireWire, Fibre Channel, a Universal Serial Bus (USB), a PCIe Advanced Switching (PCIe-AS) bus, a network 115, Infiniband, SCSI RDMA, or the like. The non-volatile memory device interface 139 may communicate with the one or more non-volatile memory devices 120 using input-output control (IO-CTL) command(s), IO-CTL command extension(s), remote direct memory access, or the like.

The communication interface 113 may comprise one or more network interfaces configured to communicatively couple the computing device 110 and/or the non-volatile memory controller 124 to a network 115 and/or to one or more remote, network-accessible storage clients 116. The storage clients 116 may include local storage clients 116 operating on the computing device 110 and/or remote, storage clients 116 accessible via the network 115 and/or the network interface 113. The non-volatile memory controller 124 comprises one or more non-volatile memory devices 120. Although FIG. 1 depicts a single non-volatile memory device 120, the disclosure is not limited in this regard and could be adapted to incorporate any number of non-volatile memory devices 120.

The non-volatile memory device 120 may comprise non-volatile memory media 122, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (SONOS), resistive RAM (RRAM), programmable metallization cell (PMC), conductive-bridging RAM (CBRAM), magneto-resistive RAM (MRAM), dynamic RAM (DRAM), phase change RAM (PRAM or PCM), magnetic storage media (e.g., hard disk, tape), optical storage media, or the like. While the non-volatile memory media 122 is referred to herein as “memory media,” in various embodiments, the non-volatile memory media 122 may more generally comprise a non-volatile recording media capable of recording data, which may be referred to as a non-volatile memory media, a non-volatile storage media, or the like. Further, the non-volatile memory device 120, in various embodiments, may comprise a non-volatile recording device, a non-volatile memory device, a non-volatile storage device, or the like.

The non-volatile memory media 122 may comprise one or more non-volatile memory elements 123, which may include, but are not limited to: chips, packages, planes, die, and the like. A non-volatile memory media controller 126 may be configured to manage storage operations on the non-volatile memory media 122, and may comprise one or more processors, programmable processors (e.g., field-programmable gate arrays), or the like. In some embodiments, the non-volatile memory media controller 126 is configured to store data on and/or read data from the non-volatile memory media 122 in the contextual, log format described above, and to transfer data to/from the non-volatile memory device 120, and so on.

The non-volatile memory media controller 126 may be communicatively coupled to the non-volatile memory media 122 by way of a bus 127. The bus 127 may comprise an I/O bus for communicating data to/from the non-volatile memory elements 123. The bus 127 may further comprise a control bus for communicating addressing and other command and control information to the non-volatile memory elements 123. In some embodiments, the bus 127 may communicatively couple the non-volatile memory elements 123 to the non-volatile memory media controller 126 in parallel. This parallel access may allow the non-volatile memory elements 123 to be managed as a group, forming a logical memory element 129. As discussed above, the logical memory element may be partitioned into respective logical memory units (e.g., logical pages) and/or logical memory divisions (e.g., logical erase blocks). The logical memory units may be formed by logically combining physical memory units of each of the non-volatile memory elements. For example, if the non-volatile memory media 122 comprises twenty-five (25) non-volatile memory elements, each logical memory unit may comprise twenty-five (25) pages (e.g., a page of each element of non-volatile memory media 122).

The non-volatile memory controller 124 may comprise an SML 130 and the non-volatile memory media controller 126. The SML 130 may provide storage services to the storage clients 116 via one or more interfaces 131, 132, and/or 133. In some embodiments, the SML 130 provides a block-device I/O interface 131 through which storage clients 116 perform block-level I/O operations. Alternatively, or in addition, the SML 130 may provide a storage management layer (SML) interface 132, which may provide other storage services to the storage clients 116. In some embodiments, the SML interface 132 may comprise extensions to the block device interface 131 (e.g., storage clients 116 may access the SML interface 132 through extensions to the block device interface 131). Alternatively, or in addition, the SML interface 132 may be provided as a separate API, service, and/or library. The SML 130 may be further configured to provide a cache interface 133 for caching data using the non-volatile memory system 102.

As described above, the SML 130 may present a logical address space 134 to the storage clients 116 (e.g., through the interfaces 131, 132, and/or 133). The SML 130 may maintain metadata 135 comprising any-to-any mappings between logical addresses in the logical address space 134 and media locations on the non-volatile memory device 120. The metadata 135 may comprise a logical-to-physical mapping structure with entries that map logical addresses in the logical address space 134 and media locations on the non-volatile memory device 120. The logical-to-physical mapping structure of the metadata 135, in one embodiment, is sparsely populated, with entries for logical addresses for which the non-volatile memory device 120 stores data and with no entries for logical addresses for which the non-volatile memory device 120 does not currently store data. The metadata 135, in certain embodiments, tracks data at a block level, with the SML 130 managing data as blocks.

The non-volatile memory system 102 may further comprise a log storage module 137, which, as described above, may be configured to store data on the non-volatile memory device 120 in a contextual, log format. The contextual, log data format may comprise associating data with a logical address on the non-volatile memory media 122. The contextual, log format may further comprise associating data with respective sequence identifiers on the non-volatile memory media 122, which define an ordered sequence of storage operations performed on the non-volatile memory media 122, as described above. The non-volatile memory controller 124 may further comprise a non-volatile memory device interface 139 that is configured to transfer data, commands, and/or queries to the non-volatile memory media controller 126 over a bus 125, as described above.

FIG. 3 depicts one embodiment of a module for triggering untriggered assertions in design verification. In one embodiment, the module 300 includes an instance of a design validation module 150. The design validation module 150, in certain embodiments, includes an assertion module 302, a dependency module 304, and a simulation module 306, which are described in more detail below.

The assertion module 302, in one embodiment, is configured to determine one or more assertions of a plurality of assertions that are associated with a verification test 101 of a design of an integrated circuit (“IC”) 103, including both assertions that are triggered and assertions that are not triggered while validating one or more behaviors of the IC design 103. As used herein, an assertion is a test, instruction, function, condition, check, rule, or the like that is used to verify or validate a function, operation, behavior, or the like of an IC. Assertions may be checked dynamically by simulation, or statically by a separate property checker tool, e.g. a formal verification tool that proves whether or not a design meets its specification.

In certain embodiments, an IC design 103 may include a design of an integrated circuit that performs various operations that can be verified and validated by running a series of tests, e.g., assertions, to test whether the operations execute correctly, whether the inputs for the operations are correct, whether the outputs of the operations are correct, and/or the like. As described above with reference to FIG. 2, assertions may be run as simulations on a virtual or simulated design, e.g., a software design of an IC, and/or a hardware embodiment of the IC design, e.g., a physical embodiment of a memory, a processor, a storage device (as depicted in FIG. 2), and/or the like that includes physical pins and electronic connections.

In some embodiments, the assertion module 302 checks a data store such as a database 107, a file, a table, a list, a log, and/or the like to determine assertions that are associated with a test of the IC design 103. For instance, during a verification test 101, which may include a plurality of various assertions intended to execute to test multiple different operations or behaviors of an IC, a summary of the assertions may be written to a database 107 to be analyzed after the verification test 101. The summary may include a name or type of each assertion, the dependencies that each assertion is based on, whether the assertion was triggered during the test, and/or the like.

The assertion module 302 may further determine which of the assertions were untriggered during the IC design test 101 by checking the data store during and/or after a verification test 101 is executed to search for assertions that have been flagged as untriggered, unexecuted, skipped, or the like. As used herein, an untriggered assertion is an assertion that was skipped or otherwise not executed during the IC design test 101. Various factors may determine whether an assertion is triggered or not. For instance, an assertion may depend on various conditions being true or false, the values of various variables, the execution of various functions or instructions, the loading of various drivers and shared libraries, the triggering of signals, and/or the like. Assertions may not be triggered due to the randomization of testing various behaviors of an IC design 103. For example, assertions may be untriggered due to mode and operation randomization (e.g., non-exercised or limited combinations of mode and operation), parameter randomization (e.g., non-randomized or limited randomization of configuration parameters or conditions), limitation of stimulus sequence (e.g., limitation of particular operation sequence or a command execution being missed out), stimulus timing (e.g., the occurrence of operation sequence at a particular time window is missed due to randomization), and/or any combination of the foregoing.

The dependency module 304, in one embodiment, is configured to determine one or more dependencies that may affect how, when, and/or under which conditions an assertion is triggered. As used herein, dependencies may comprise shared libraries, drivers, logic paths, conditions, factors, variables, parameters, and/or the like that are associated with an assertion. The dependency module 304, for instance, may check the data store of assertions to determine the various dependencies associated with the untriggered assertions that the assertion module 302 identifies.

The dependency module 304, in certain embodiments, identifies which portions of the dependencies of an untriggered assertion are modifiable so that adjustments can be made to the dependencies to cause the untriggered assertions to be triggered. For example, if an assertion is a conditional test to determine whether a variable is equal to a value, and the variable is always equal to the value, then the assertion is not triggered when the variable is not equal to the value. In other words, the logic path that is followed when the variable is not equal to the value is not triggered during the verification test, and therefore it is not known whether the logic path behaves correctly, or as intended, when the variable is not equal to the value. Therefore, the dependency module 304 may identify one or more variables, parameters, functions, signals, and/or the like that may be modified in order to trigger the untriggered assertion, or the portion of the assertion that leads to an untriggered logic path, or the like.

In certain embodiments, the dependency module 304 traces one or more drivers associated with an assertion to determine the dependencies that affects the assertion. For instance, if an assertion is intended to test a write operation on a storage device, but the assertion module 302 determines that the assertion is not triggered, the dependency module 304 may trace a storage driver's operations or functions, e.g., a debug log of the storage driver, to determine functions, variables, conditions, or the like that affect when the assertion is triggered. One of skill in the art will recognize the various ways to trace the functions, operations, variables, or the like of a driver before, during, and after a driver is loaded.

In some embodiments, the dependency module 304 traces convergence cone logic associated with an assertion to determine one or more dependency that affect whether an assertion is triggered. As used herein, a convergence logic cone is a group of logic conditions that is affected by various inputs such as variables, function input/output, register values, black box input/output, port input/output, and/or the like, which converges to one or more outputs. The dependency module 304 may trace variables, functions, signal sources, and/or the like of a convergence cone backward and/or forward during or after a verification test to determine which inputs/outputs may affect whether an assertion is triggered.

In one embodiment, the simulation module 306 generates one or more testing scenarios, simulations, and/or the like for the IC design 103, based on the one or more dependencies, to trigger one or more untriggered assertions. For example, the simulation module 306 may generate a testing scenario, by following or predicting the logic paths of the identified dependencies, that causes a variable to be set to a particular value in order to trigger a particular assertion, or logic path associated with an assertion. The simulation module 306 may generate a testing scenario that can be executed in software, e.g., as a simulation on a software design, or in hardware by generating electronic signals to test a physical embodiment of an IC. For example, the simulation module 306 may generate a simulation that utilizes SystemVerilog® or similar hardware description and/or verification language.

In one embodiment, the simulation module 306 is further configured to place the one or more testing scenarios in a queue and execute the testing scenarios in a first-in-first-out (“FIFO”) order. In such an embodiment, the testing scenarios may each comprise a sequence of instructions, functions, commands, or the like that are executed in a particular order to trigger the untriggered assertions. Furthermore, a testing scenario may be based on output or side effects generated by a previously executed testing scenario. Thus, the simulation module 306, in one embodiment, maintains an order of the sequence of operations of a testing scenario and the order of execution of the testing scenarios to ensure that the untriggered assertions are triggered by popping sequences of a testing scenario off the top of the queue one by one and executing each sequence in order. The simulation module 306, in certain embodiments, waits for a response that an executing sequence has completed before popping the next sequence off the top of the queue and executing the sequence.

FIG. 4 depicts one embodiment of a module for triggering untriggered assertions in design verification. In one embodiment, the module depicted in FIG. 4 includes an instance of a design validation module 150. The design validation module 150 may include one or more of an assertion module 302, a dependency module 304, and a simulation module 306, as described above with reference to FIG. 3. Furthermore, in certain embodiments, the design validation module 150 includes one or more of a test module 402, a dependency module 404, a sequence module 406 (as part of the simulation module 306), a configuration module 408 (as part of the simulation module 306), and a presentation module 410.

The test module 402, in one embodiment, is configured to execute an initial verification test 101 to that includes a plurality of assertions intended to test an IC design 103. In certain embodiments, the verification test 101, and the assertions comprising the verification test, may be based on a constrained random verification methodology such as a universal verification methodology (“UVM”) that randomly triggers one or more assertions of the verification test while testing one or more behaviors of the IC design 103. As used herein, a constrained random verification methodology such as UVM is a standardized methodology for verifying IC designs 103 that utilizes a constrained random verification method to test IC designs 103. Based on the results of the initial verification test 101, the assertion module 302 may determine which assertions are triggered during the verification test 101, and which assertions are not triggered during the verification test 101.

During, or after, the initial verification test 101, the test module 402 populates the data store with information about the assertions that were triggered and/or not triggered during execution of the verification test 101. The test module 402, for instance, may populate a database 107 with information captured during the verification test 101 as it relates to each assertion of the verification test 101. The information may include a flag that indicates whether the assertion was triggered, a flag that indicates whether the assertion executed successfully or not, information about portions of the IC design that were covered or tested during the verification test 101, one or more dependencies that affect an assertion, and/or the like.

After the initial verification test 101, in certain embodiments, the assertion module 302 checks the data store to determine which assertions haven't been triggered, the dependency module 304 determines which dependencies affect the untriggered assertions, and the simulation module 306 designs a simulation, test scenario, or the like to trigger the untriggered assertions for a particular IC design 103, as described above. The test module 402, in various embodiments, executes, or runs the simulation, test scenario, or the like, that the simulation module 306 generates to trigger the assertions that were not triggered during the initial verification test 101. The simulation, for example, may include an instance of a verification test 101 with one or more dependency values that have been changed, modified, or adjusted to trigger execution of one or more assertions that were not triggered during a previous verification test. Thus, the test module 402, in one embodiment, determines, identifies, or the like, which of the dependency values or logic paths are modifiable (e.g., logic paths may be changed or predicted based on changing values that cause the order of execution to follow a particular logic path), what the values should be modified to in order to trigger an untriggered assertion, and/or the like to trigger the untriggered assertions.

In one embodiment, the dependency analysis module 404 is configured to analyze the one or more dependencies that the dependency module 304 identifies for each of the untriggered assertions to determine various factors, parameters, variables, logic paths, drivers, functions, signals, and/or the like that affect whether an assertion is triggered. In particular, the dependency analysis module 404, in one embodiment, determines one or more dependent logic paths associated with triggering the untriggered assertion. The dependent logic paths, for example, may comprise a series of instructions, conditions, and variables that follow a particular logic path for an operation based on the dependency settings, e.g., the logic values of the dependencies. For example, a write operation may have various logic paths such as a path that leads to a successful data write, a path that leads to an unsuccessful write, a path that leads to various error conditions, and/or the like, which may each be based on various inputs, conditions, parameters, factors, variables, and/or the like. The dependency analysis module 404, may analyze, trace, or scan a debug log, or similar output log, of a verification test 101 to determine the dependent logic paths associated with an assertion.

The dependency analysis module 404, in a further embodiment, is configured to determine one or more logic values for the one or more dependent logic paths associated with triggering an untriggered assertion. For instance, the dependency analysis module 404 may analyze a debug or output log to determine the logic values that may affect which dependent logic path is followed during execution of an operation of the IC design 103. For example, the dependency analysis module 404 may identify a variable that when set to a certain value causes a particular logic path to be executed, but when the variable is set to a different value, a different logic path is executed, e.g., such as variables in a conditional statement. If an assertion is intended to test a behavior associated with a particular logic path, but that logic path is never executed because the variable is not set to a value that causes the logic path to be executed, then that assertion will not be triggered during a verification test 101. The dependency analysis module 404 ay identify this discrepancy and indicate to the simulation module 306 that the logic values for the logic path associated with the untriggered assertion should be modified prior to executing another verification test 101.

The dependency analysis module 404, in a further embodiment, is configured to determine one or more modes of operation associated with triggering an untriggered assertion. The modes of operation may include different execution modes for an IC device may execute such as an erase mode, a write mode, a program mode, a processing mode, a garbage collection mode, and/or the like.

The dependency analysis module 404, in one embodiment, is configured to determine one or more parameters associated with triggering an untriggered assertion. For instance, the dependency analysis module 404 may determine global and local variables, signals, macros, settings, and/or the like that affect whether an assertion is triggered or not. The parameters may be found in the code itself (e.g., in a driver, a shared library, a source code file, or the like), in a configuration file that is read during execution, and/or the like.

The dependency analysis module 404, in some embodiments, is configured to determine one or more temporal relationships between the signals, conditions, factors, variables, tests, functions, or the like that cause the untriggered assertion to be triggered. For example, the dependency analysis module 404 may determine that function A needs to be executed before function B, which triggers an assertion, can execute. Thus, the dependency analysis module 404 may determine that there is a temporal relationship between function A and function B, and that further analysis is needed to determine the dependencies that trigger function A.

The sequence module 406, in one embodiment, is configured to determine a sequence of events, instructions, commands, functions, or the like for generating a testing scenario based on the analyzed dependencies for triggering the untriggered assertion. As used herein, a sequence of events includes an execution order for different commands, functions, instructions, signals, and/or the like that trigger an untriggered assertion. For example, the sequence of events may include setting/reading variables or parameters, executing functions, reading/writing data, loading shared libraries, sending or receiving signals, and/or the like. As described above, the sequence of events, and the order that the events are executed, may determine whether an untriggered assertion is triggered during execution of the testing scenario. The sequence module 406 may place the sequences for a testing scenario in a FIFO queue such that the sequence module 406 can pop the sequences off the queue one by one in response to the completed execution of a previously executed sequence. Thus, the order in which the events are executed may be important to set up or predict a logic path that triggers the untriggered assertion.

The sequence module 406, in order to generate a sequence of events, considers the various dependencies for an untriggered assertion, e.g., the various logic paths, logic path values, modes of operations, temporal relationships, and parameters to determine or predict a sequence of events that will trigger the untriggered assertion. Based on the various dependency inputs for triggering the untriggered assertion, the sequence module 406 can identify commands, functions, shared libraries, drivers, signals, or the like that should be called, executed, loaded, or the like to trigger the untriggered assertion.

The configuration module 408, in one embodiment, is configured to modify a configuration of one or more dependencies associated with an untriggered assertion so that the untriggered assertion can be triggered during execution of the testing scenario that the simulation module 306 designs. A dependency configuration may include parameters, variables, constants, conditional statements, signals, and/or the like that may be modified, adjusted, changed, or the like, which may affect how a sequence of events is executed, and ultimately trigger and untriggered assertion. The configuration module 408, in one embodiment, predicts the modified values for the various parameters of the configuration based on the simulation log, debug log, or the like of a previously executed verification test 101, and the dependencies that the dependency analysis module 404 identifies and analyses. The configuration module 408, in some embodiments, modifies settings in one or more configuration files associated with the dependencies, modifies logic values, constants, and/or the like before or during run-time of a verification test 101.

In one embodiment, based on the modified configuration values and the generated sequences, the test module 402 re-runs a verification test 101 to trigger one or more untriggered assertions. Accordingly, after the verification test 101 is completed, the assertion module 302 may check the data store, simulation log, or the like to determine if there are any untriggered assertions remaining. If so, the process begins again to identify dependencies for the untriggered assertions, modifying the dependency configurations, generating a sequence of events to trigger the untriggered assertion, and executing the verification test 101 to execute the sequence of events.

The presentation module 410, in one embodiment, is configured to present the one or more testing scenarios to a user that are associated with untriggered assertions so that the user can select which testing scenario(s) the user would like to execute. The testing scenarios that the presentation module 410 presents to the user may comprise a plurality of different assertions for testing a specific operation of an IC that is associated with the IC design 103. For example, if the IC design that is under test is for a non-volatile storage device, the testing scenario may include assertions to test a write operation, a read operation, a garbage collection operation, and/or the like. Thus, the presentation module 410 may present a list of testing scenarios to test various operations of a particular IC device, e.g., a storage device, a memory device, a processor, a network card, a video card, or the like; of a system that includes multiple different IC devices; and/or the like.

The presentation module 410 may receive a selection of one or more testing scenarios from the user and execute the selected testing scenarios to trigger the untriggered assertions associated with the particular testing scenario. In this manner, the user can select which operations the user would like to focus on with respect to assertions that were not triggered without requiring a full test suite to test each of the untriggered assertions. In other words, the user can select which untriggered assertions the user would like to have executed, while ignoring or disregarding other untriggered assertions that are not of interest to the user.

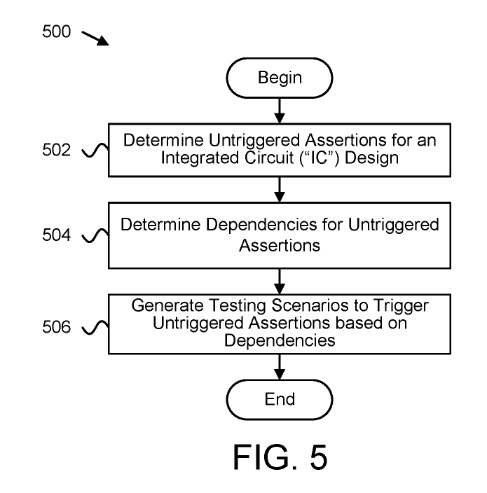

FIG. 5 is a schematic flow-chart diagram illustrating one embodiment of a method 500 for triggering untriggered assertions in design verification. In one embodiment, the method 500 begins, and the assertion module 302 determines 502 one or more assertions of a plurality of assertions associated with an IC design 103 that have not been triggered during a verification test 101 of the IC design 103. In some embodiments, the plurality of assertions is intended to test one or more behaviors of the IC design 103.

In a further embodiment, the dependency module 304 determines 504 one or more dependencies for the one or more untriggered assertions. The one or more dependencies, in some embodiments, affect how, when, or under what conditions an assertion is triggered. In various embodiments, the simulation module 306 generates 506 one or more testing scenarios for the IC design based on the one or more dependencies in order to trigger the one or more untriggered assertions, and the method 500 ends.

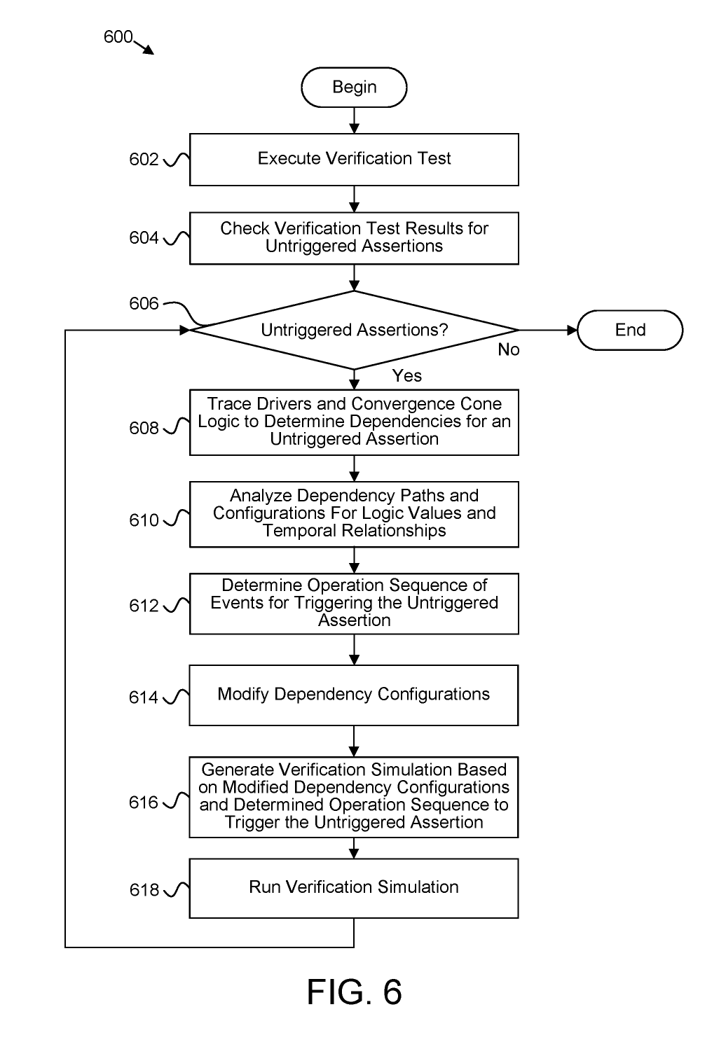

FIG. 6 is a schematic flow-chart diagram illustrating one embodiment of a method 600 for triggering untriggered assertions in design verification. In one embodiment, the method 600 begins and the test module 402 executes 602 a verification test 101, which may include a plurality of assertions for verifying one or more behaviors, functions, operations, or the like of an IC design 103. The test module 402 may track and store the results of the verification test in a data store, e.g., a database 107 that the assertion module 302 can check 604 to determine whether there are any assertions that were not triggered during execution of the verification test 101.

If the assertion module 302 determines 606 that all of the assertions were triggered during the verification test 101, then the method 600 ends. Otherwise, the assertion module 302 identifies the one or more untriggered assertions, and for each assertion, the dependency module 304 traces 608 drivers, convergence cone logic, simulation logs, debug logs, and/or the like to determine dependencies for each untriggered assertion. The dependencies may include parameters, settings, variables, conditions, functions, shared libraries, drivers, signals, and/or the like that may affect whether an assertion is triggered.

The dependency analysis module 404, in one embodiment, analyzes 610 the determined dependencies to identify logic paths, logic values, operations, modes, temporal relationships, and/or the like that may affect how a dependency is executed, and ultimately may determine whether an assertion is triggered. The sequence module 406, in some embodiments, determines 612 or predicts an operation sequence of events for triggering the untriggered assertions based on the dependency analysis. The sequence of events may include instructions, functions, commands, signals, and/or the like that are executed or processed in a particular order, which may trigger the untriggered assertion.

The configuration module 408 identifies and modifies 614 one or more configuration settings, parameters, variables, values, constants, conditions, signal settings, and/or the like to adjust the dependency settings and trigger the untriggered assertion. Based on the modified configuration settings and the identified sequence of events, the simulation module 306 generates 616 a test scenario or simulation to trigger the untriggered assertion and verify the operations or behaviors associated with the untriggered assertion. In a further embodiment, the test module 402 runs 618 the simulation, and the assertion module 302 determines 606 whether there are any remaining untriggered assertions to process.

### Example Embodiment

Below is an example embodiment of generating a testing scenario from an assertion using an assertion from a memory control module:
wire ALL_UCG_V_SET=((erase_mode) & ((er1 & (CGDIS_ERA_EN)))) ;
wire ALL_UCG_V_RST=((erase_mode) & ((er4 & (CGDIS_ERA_EN))));
wire ALL_UCG_V_DIS=1′b0;
property signal_setrst_low(a,set,rst, dis);
   @(posedge TMOSC_FSM or negedge LOWVDDRSTEn_dly) disable iff
   (˜LOWVDDRSTEn_dly)
   ((˜a&$past(a))|(a&˜$past(a)))&˜dis|−>if (a) ($past(set)else($past(rst)
         |$past(SeqEnd)|SeqEnd);
endproperty
ass_ALL_UCG_V_p1: assert
property (signal_setrst_low(ALL_UCG_V,ALL_UCG_V_SET,ALL_UCG_V_RST,ALL_UCG_V_DIS))
else $display(“% 0t ass_ALL_UCG_V_p1 failed with % 0s mode”, $time, COMMENT);

In the above example the assertion “ass_ALL_UCG_V_p1,” for example, checks that the signal “ALL_UCG_V” changed because of set or reset condition. If this particular assertion is not triggered, then the dependency module 304 may look at the dependencies for this assertions. For example, the signal “ALL_UCG_V” for which the check is performed, which is an active low signal; the signal “ALL_UCG_V_SET,” which determines what the set condition is, and which in turn depends on mode “erase_mode” and signal “er1” and the parameter “CGDIS_ERA_EN”; the signal “ALL_UCG_V_RST,” which determines what the reset condition is, and which in turn depends on signals mode “erase_mode” and signal “er4” and the parameter “CGDIS_ERA_EN.”

So, in order to trigger the assertion “ass_ALL_UCG_V_p1,” there are two possible testing scenarios for the signal “ALL_UCG_V” to be changed based on whether “ALL_UCG_V_V_SET” is set to high, or whether “ALL_UCG_V_RST” is set to high. Accordingly, the simulation module 306 may generate two different testing scenarios based on the dependencies:

Scenario 1:
ALL_UCG_V _SET=1,
So the dependent signal values are:
   erase_mode=1
   er1=1
And the dependent parameter value is:
   CGDIS_ERA_EN=1
The erase operation with CGDIS_ERA_EN parameter enabled and er1=1.

Scenario 2:
ALL_UCG_V_RST=1,
So the dependent signal values are:
   erase_mode=1
   er4=1
And the dependent parameter value is:
   CGDIS_ERA_EN=1
The erase operation with CGDIS ERA EN parameter enabled and er4=1.

In one embodiment, the test module 402 stores the above assertion and dependency information in a data store, in addition to other data not shown, so that it can be referenced to determine the assertions and their dependencies, and configuration parameters, that affect how an assertion is triggered. The test module 402, for example, may use debugging tools such as Verdi or Dye by Synopsys, which stores the above metadata information in a database, and/or Irun/Simvision by Cadence, which stores the above metadata information in a file such as INCA_libs/irun.<ver>.nc. With these tools, and others not mentioned here, the test module 402 may trace a driver to determine the dependency information, which ultimately may be used to predict an expected scenario that comprises one or more sequences generated based on the dependencies.

A means for determining one or more untriggered assertions, in various embodiments, may include an assertion module 302, a design validation module 150, a processor, an FPGA, an ASIC, a computing device 110, a hardware tester device, other logic hardware, and/or other executable code stored on a computer readable storage medium. Other embodiments may include similar or equivalent means for determining one or more untriggered assertions.

A means for determining one or more dependencies for the one or more untriggered assertions, in various embodiments, may include a dependency module 304, a design validation module 150, a processor, an FPGA, an ASIC, a computing device 110, a hardware tester device, other logic hardware, and/or other executable code stored on a computer readable storage medium. Other embodiments may include similar or equivalent means for determining one or more dependencies for the one or more untriggered assertions.

A means for generating one or more testing scenarios based on the one or more dependencies for triggering the one or more untriggered assertions, in various embodiments, may include a simulation module 306, a design validation module 150, a processor, an FPGA, an ASIC, a computing device 110, a hardware tester device, other logic hardware, and/or other executable code stored on a computer readable storage medium. Other embodiments may include similar or equivalent means for generating one or more testing scenarios based on the one or more dependencies for triggering the one or more untriggered assertions.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A method comprising:
determining one or more assertions of a plurality of assertions that are not triggered while validating one or more behaviors of an integrated circuit (“IC”) design, the plurality of assertions testing a validity of the one or more behaviors of the IC design;
determining one or more dependencies for the one or more untriggered assertions, the one or more dependencies for an untriggered assertion affecting how an assertion is triggered; and
generating one or more testing scenarios for the IC design, based on the one or more dependencies, for triggering the one or more untriggered assertions.

2. The method of claim 1, further comprising executing a verification test for the IC design using the plurality of assertions, the verification test based on a constrained random verification methodology that randomly triggers one or more assertions of the plurality of assertions during verification testing of the one or more behaviors of the IC design.

3. The method of claim 2, wherein the one or more untriggered assertions comprise one or more assertions of the plurality of assertions that were not executed during the verification test.

4. The method of claim 2, further comprising populating a database with information captured during the verification test associated with each assertion, the information associated with an assertion comprising one or more of a flag indicating whether the assertion executed, a flag indicating whether the assertion executed successfully, information about the portions of the IC design that were covered during the verification test, and dependencies for the assertion.

5. The method of claim 4, further comprising checking the database after execution of the verification test to identify the one or more assertions that were not triggered during the verification test.

6. The method of claim 1, further comprising tracing one or more of drivers and convergence cone logic associated with an untriggered assertion to determine the one or more dependencies that trigger the untriggered assertion.

7. The method of claim 6, further comprising analyzing the one or more dependencies to determine one or more of:
one or more dependent logic paths associated with triggering the untriggered assertion;
one or more logic values for the one or more dependent logic paths associated with triggering the untriggered assertion;
one or more modes of operation associated with triggering the untriggered assertion;
one or more parameters associated with triggering the untriggered assertion; and
one or more temporal relationships between the untriggered assertion and one or more different assertions associated with triggering the untriggered assertion.

8. The method of claim 7, further comprising determining a sequence of events for generating a testing scenario based on the analyzed dependencies for triggering the untriggered assertion.

9. The method of claim 8, further comprising modifying a configuration of one or more dependencies associated with the untriggered assertion for triggering the untriggered assertion based on the analyzed dependencies.

10. The method of claim 9, further comprising re-running the verification test based on the sequence of events for the testing scenario with the one or more modified dependency configurations to trigger the untriggered assertion.

11. The method of claim 1, wherein the one or more testing scenarios are placed in a queue and executed in a first-in-first-out order such that completion of a first testing scenario selected from the queue triggers execution of a second testing scenario.

12. The method of claim 1, further comprising presenting the one or more testing scenarios to a user, wherein one or more testing scenarios are executed in response to the user selecting one or more testing scenarios from the presented one or more testing scenarios to be executed.

13. The method of claim 12, wherein one or more of the testing scenarios presented to the user comprises a plurality of different assertions for testing a specific operation of an integrated circuit associated with the IC design.

14. The method of claim 1, wherein the IC design is a design for a non-volatile storage device.

15. An apparatus comprising:
means for determining one or more tests that were not triggered for execution during validation testing of an integrated circuit (“IC”);
means for determining one or more conditions that trigger execution of the one or more untriggered tests during validation testing of the IC; and
means for simulating execution of the one or more untriggered tests by modifying the one or more conditions to trigger execution of the one or more tests.

16. The apparatus of claim 15, further comprising means for determining one or more of drivers and convergence cone logic associated with an untriggered test to determine the one or more conditions that trigger the one or more untriggered tests.

17. The apparatus of claim 16, further comprising means for analyzing the one or more conditions to determine one or more of:
one or more dependent logic paths associated with triggering the one or more untriggered tests;
one or more logic values for the one or more dependent logic paths associated with triggering the one or more untriggered tests;
one or more modes of operation associated with triggering the one or more untriggered tests;
one or more parameters associated with triggering the one or more untriggered tests; and
one or more temporal relationships between the one or more untriggered tests and one or more different tests associated with triggering the one or more untriggered tests.

18. The apparatus of claim 17, further comprising means for determining a sequence of events for generating a simulation based on the analyzed one or more conditions for triggering the one or more untriggered tests.

19. The apparatus of claim 15, further comprising means for verifying that the one or more untriggered tests were triggered according to the modified one or more conditions during execution of the one or more simulations.

20. A computer program product comprising a computer readable storage medium storing computer usable program code executable to perform operations, the operations comprising:
executing a verification test for an integrated circuit (“IC”), the verification test comprising one or more assertions configured to test one or more operations of the IC;
determining one or more assertions of the verification test that were not triggered during execution of the verification test; and
re-executing, dynamically, the verification test with one or more adjusted parameters, the one or more adjusted parameters associated with one or more dependencies that affect triggering of the one or more untriggered assertions.
